(19) United States
(12) Patent Application Publication
(10) Pub. No.: US 2007/0025611 A1
(43) Pub. Date: Feb. 1, 2007

(54) Device and method for classification

(75) Inventors: Yamato Kanda, Hino-shi (JP); Susumu Kikuchi, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/546,479

(22) Filed: Oct. 11, 2006

Related U.S. Application Data
(63) Continuation of application No. PCT/JP05/07228, filed on Apr. 14, 2005.

(30) Foreign Application Priority Data
Apr. 14, 2004 (JP) 2004-119291

(51) Int. Cl. G06K 9/00; G06K 9/62

(52) U.S. Cl. 382/149; 382/224

(57) ABSTRACT

A classification device includes area extracting unit for extracting a plurality of areas from an image, classifying unit for classifying the extracted areas into predetermined categories, and representative category deciding unit for deciding a representative category of the entire image based on a classification result of the area in the image.

### CROSS-REFERENCE TO RELATED APPLICATIONS

This is a Continuation Application of PCT Application No. PCT/JP2005/007228, filed Apr. 14, 2005, which was published under PCT Article 21(2) in Japanese.

This application is based upon and claims the benefit of priority from prior Japanese Patent Application No. 2004-119291, filed Apr. 14, 2004, the entire contents of which are incorporated herein by reference.

### BACKGROUND OF THE INVENTION

1. Field of the Invention

The present invention relates to a device and a method for classification.

2. Description of the Related Art

At present, there are available various devices for carrying out classification by using images obtained by imaging test objects. These devices can be classified into a type in which there is only one target to be classified in a processed image and a type in which there are a plurality of targets to be classified in a processed image. As a specific example, a defect classification device used for a manufacturing process of a semiconductor wafer will be considered.

In the case of defect classification of microinspection which targets very small defects such as wiring pattern abnormalities or crystal defects, predetected defect places are locally expanded and imaged, and target defects are classified by using images thereof. Accordingly, this case corresponds to the type in which there is only one target to be classified in a processed image.

On the other hand, in the case of defect classification of macroinspection which images an image of an entire wafer by a low magnification of a naked eye to target defects of a wide range such as a resolution failure, an uneven film, a flaw, and a foreign object, a plurality of defects may be present in the image. Accordingly, this case corresponds to the type in which there are a plurality of targets to be classified in a processed image.

In the latter case, macroinspection of the test object is advantages in that results unknown in local inspection or analysis can be obtained, and the same range can be processed at a higher speed, and thus it is a method useful in various fields.

Jpn. Pat. Appln. KOKAI Publication No. 2003-168114 of the inventors discloses a configuration concerning a defect classification device of macroinspection which targets a semiconductor wafer or the like. A principle of this defect classification will be described below by referring to FIG. 18. A to-be-inspected image 800 ((A) of FIG. 18) obtained by imaging an entire surface of a test object generally contains an analysis failure 801, unevenness 802, a flaw 803, and the like. Such a to-be-inspected image 800 is compared with a good quality image 850 ((B) of FIG. 18) to obtain a difference image 860 ((C) of FIG. 18). By subjecting this difference image 860 to processing such as binarization, a defect area extraction image 870 in which defect areas 871 to 873 are extracted is obtained((D) of FIG. 18). Next, feature values (tentatively feature values 1, 2, 3, . . . in the drawing) concerning sizes, shapes, arrangements or luminance of the extracted defect areas 871 to 873 are calculated to obtain feature value information of each area as shown in (A) of FIG. 19. By using this information and a classification table (IF-THEN rule of a fuzzy theory) shown in (B) of FIG. 19, the defect areas 871 to 873 are classified into predetermined defect types (=categories). As a result, for example, the following classification results are output:

Defect area 871→unevenness (certainty factor: 0.6)

Defect area 872→resolution failure (certainty factor: 0.9)

Defect area 873→flaw (certainty factor: 0.8)

### BRIEF SUMMARY OF THE INVENTION

According to a first feature of the invention, a classification device includes area extracting unit for extracting a plurality of areas from an image, classifying unit for classifying the extracted areas into predetermined categories, and representative category deciding unit for deciding a representative category of the entire image based on a classification result of the areas of the image.

According to a second feature of the invention, in the classification device of the first feature, the representative category is decided by using at least one of a value of a presence ratio of each area in the image, a value indicating reliability of a classification result of each area, and priority of each category.

According to a third feature of the invention, in the classification device of the second feature, the value indicating the presence ratio of the area is represented by at least one of the number of areas for each category in the image, a total area of each category, and the number of occupied sections for each category when the inside of the image is divided into sections by optional sizes.

According to a fourth feature of the invention, in the classification device of the second feature, the value indicating the reliability is calculated based on a distance of a feature value space used for classification.

According to a fifth feature of the invention, in the classification device of the first feature, the plurality of classification target areas are defect areas when a surface of a test object is imaged.

According to a sixth feature of the invention, in the classification device of the fifth feature, the priority is set in accordance with criticalities of the defect areas.

According to a seventh feature of the invention, in the classification device of the first feature, the test object is a semiconductor wafer or a flat panel display substrate.

According to an eighth feature of the invention, in the classification device of the seventh feature, the image is an interference image or a diffraction image.

According to a ninth feature of the invention, the classification device of the first feature further includes display unit for switching the detected category of each area with the representative category of the entire image to display the category.

According to a tenth feature of the invention, in the classification device of the ninth feature, an image of a processing target is displayed together when the category is displayed by the display unit.

According to an eleventh feature of the invention, in the classification device of the tenth feature, the image of the processing target is displayed by using different colors for the extracted areas or visible outlines of the extracted areas for each category.

According to a twelfth feature of the invention, a classification method includes a step of extracting a plurality of areas from an image, a step of classifying the extracted areas into predetermined categories, and a step of deciding a representative category of the entire image based on a classification result of the areas in the image.

### BRIEF DESCRIPTION OF THE SEVERAL VIEWS OF THE DRAWING

FIG. 1 is a diagram showing a configuration of a defect classification device according to an embodiment of the present invention.

FIG. 2 is an explanatory diagram showing a first method of defect area extraction.

FIG. 3 is an explanatory diagram showing a second method of defect area extraction.

FIG. 4 is a diagram showing an example of area connection processing using a morphology process (closing process).

FIG. 5 is a diagram showing an example of a membership function.

FIG. 6 is an explanatory diagram of a principle of defect type determination based on a classification rule using a membership function.

FIG. 7 is an explanatory diagram of a principle of defect type determination based on a k neighborhood method.

FIG. 8 is an explanatory diagram of a principle of defect type determination based on a distance from a representative point of a teacher data distribution.

FIG. 9 is a table showing classification result data of each area.

FIG. 10 is a table showing classification result data of each defect type.

FIG. 11 is an explanatory diagram showing a difference between a human determination result of a to-be-inspected image and a determination result based on the number of areas or a determination result based on an area..

FIG. 12 is a diagram showing a situation of occupied sections of a flaw 200, unevenness 201 of FIG. 11.

FIG. 13 is a table showing a result of selecting an area of a high reliability index value in the table of each area classification result data.

FIG. 14 is a table showing each defect type classification result data based on the area selected in FIG. 13.

FIG. 15 is a diagram showing a display screen of representative defect type information and a to-be-inspected image.

FIG. 16 is a diagram showing a display screen of a detailed classification result of a slot 03 of FIG. 15.

FIG. 17 is a flowchart showing a processing flow of the defect classification device of the embodiment.

FIG. 18 is an explanatory diagram of a principle of a conventional defect classification method.

FIG. 19 is a diagram showing an example of a feature value calculated for each defect area and a classification rule.

### DETAILED DESCRIPTION OF THE INVENTION

The preferred embodiments of the present invention will be described below in detail with reference to the drawings. Explanation will be made by way of case in which the invention is applied to a defect classification device used for macroinspection targeting a semiconductor wafer or a flat panel display substrate. However, this case is in no way limitative, but the invention can be applied to, e.g., a purpose of classifying plural kinds of cells and displaying a representative result.

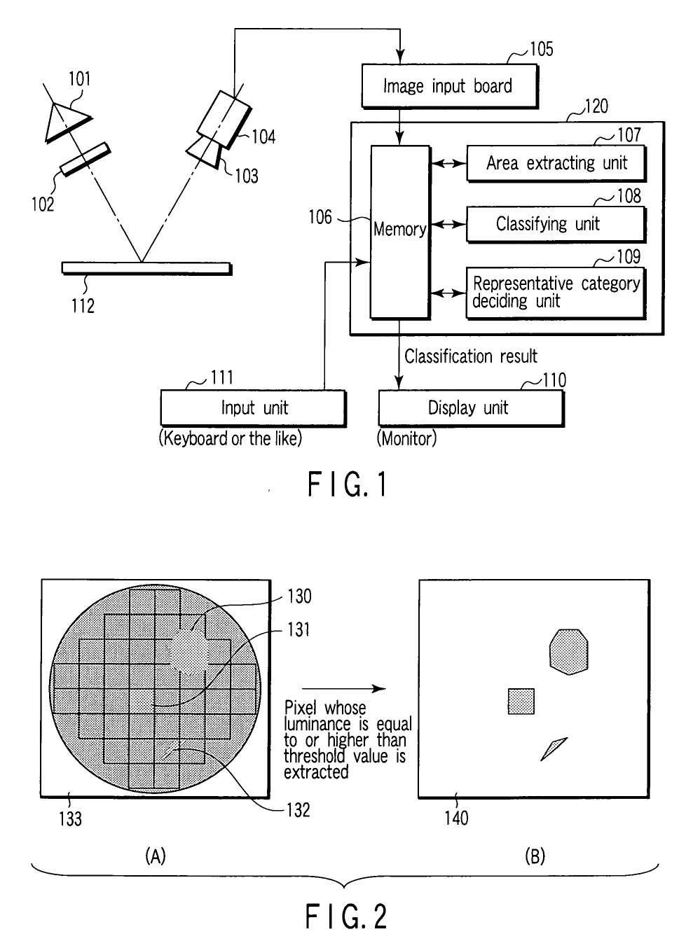

FIG. 1 shows a configuration of a defect classification device according to an embodiment of the present invention. This defect classification device includes an illuminator 101 for illuminating a test object 112, a band-pass filter 102 for limiting a wavelength of an illumination light from the illuminator 101, a lens 103 for forming an image by a reflected light from the test object 112, a CCD camera 104 for converting the formed test object image into an helectric signal, an image input board 105 for capturing a signal from the CCD camera 104 as an image, a memory 106 used for storing image data and processing of each unit described below, area extracting unit 107 for extracting defect areas of classification targets from the image, classifying unit 108 for classifying the extracted defect areas into predetermined defect types (or grades), representative category deciding unit 109 for deciding a representative category in the entire image based on a classification result of the areas, display unit 110 for displaying the classification result, and input unit 111 for setting various settings necessary for the above-described units from the outside. The memory 106 is realized by a memory in a PC 120, the area extracting unit 107, the classifying unit 108 and the representative category deciding unit 109 are realized by a CPU in the PC 120, the display unit 110 is realized by a monitor, and the input unit 111 is realized by a keyboard or the like.

An operation of the defect classification device will be described. A light from the illuminator 101 is subjected to wavelength limitation at the band-pass filter 102 to be applied to the test object 112. A diffracted light (or interference light) reflected from a surface of the test object 112 is caused to form an image, and converted into an electric signal by the CCD camera 104.

The diffracted light (or interference light) is obtained in order to sufficiently image defects such as a resolution failure, film unevenness, a flaw and a foreign object to be targeted by the macroinspection of the semiconductor wafer. For example, in a place of the resolution failure, a diffraction angle with respect to an illumination light is different from that of a normal part as sagging occurs in a very small concave/convex pattern of the surface. Thus, imaging is facilitated by obtaining the diffracted light.

Because of a change in a thickness of a transmissive resist material, the film unevenness is easily imaged by obtaining an interference light in which a light amount difference is obtained according to a thickness of a resist. The flaw, the foreign object or the like is a defect to be easily imaged by both of a diffracted light and an interference light because of surface scratching or object sticking. While an imaging level (=size of contrast with the normal part) changes, the resolution failure and the film unevenness can be imaged by respectively using the interference light and the diffracted light.

The electric signal from the CCD camera 104 is digitized through the image input board 105, and captured into the calculation memory 106. This becomes a to-be-inspected image 133 ((A) of FIG. 2) of the test object. Next, the area extracting unit 107 extracts defect areas of the obtained to-be-inspected image 133.

As extraction methods, two methods will be described. According to a first method, a threshold value which becomes a luminance level of a nondefective article level is first set for the to-be-inspected image 133, and an area of a pixel having luminance exceeding this threshold value is extracted as a defect extraction image 140 ((B) of FIG. 2). In this case, the threshold value indicating the luminance range of the nondefective article level may be preset in the PC 120, or adaptively decided based on a luminance histogram in the image (p. 502, Binarization, edited by Mikio Takagi, Yoshihisa Shimoda: Image Analysis Handbook by Tokyo University Publishing).

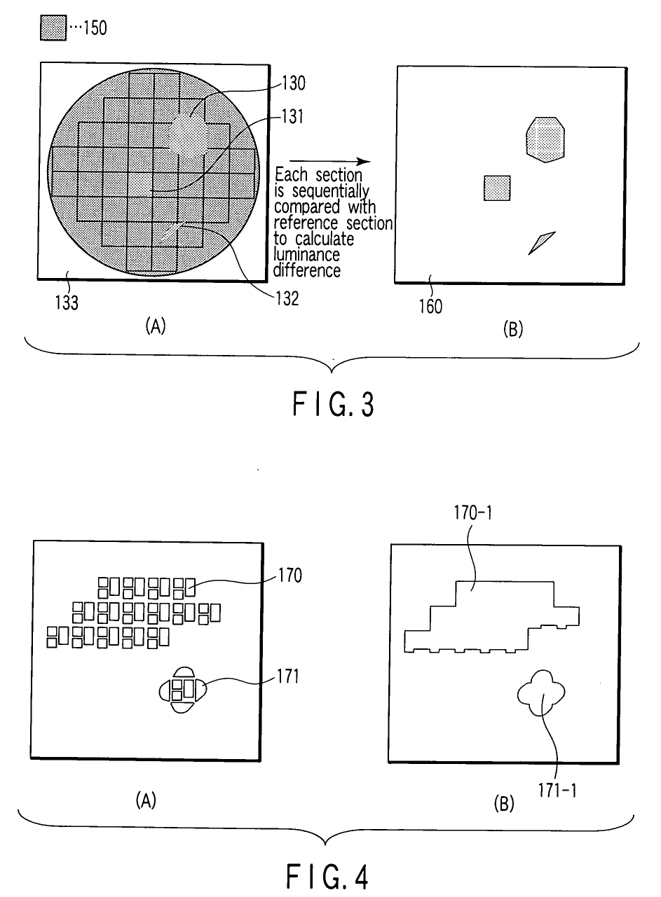

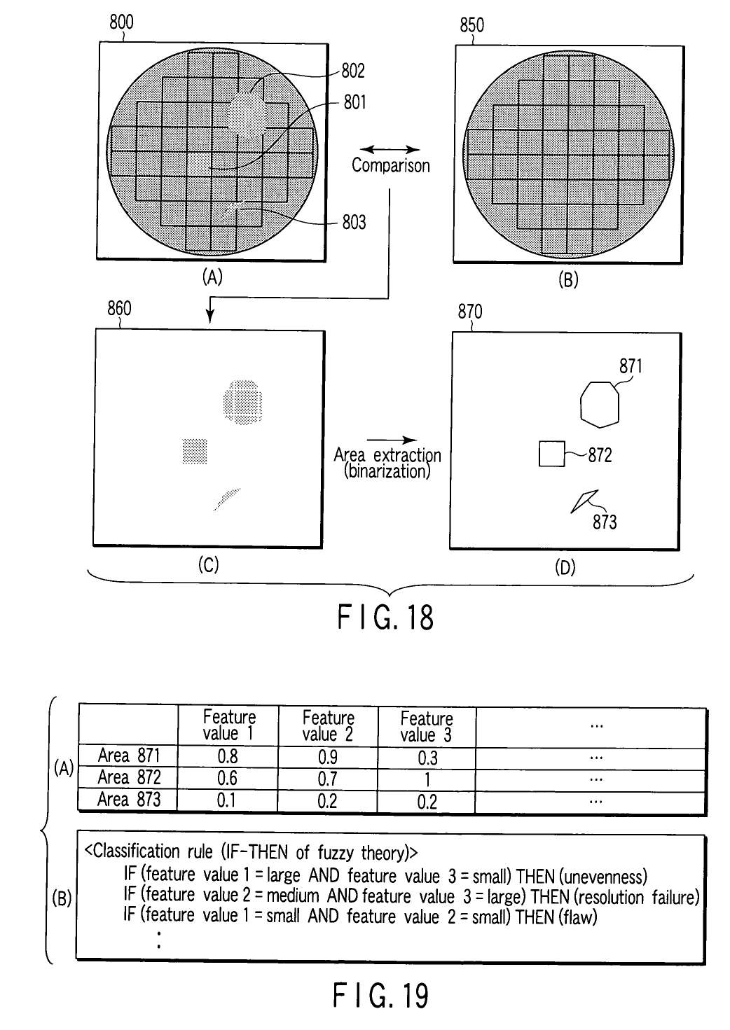

According to a second method, a nondefective article wafer image 850 shown in (B) of FIG. 18 (or image 150 of a certain section which becomes a nondefective article shown in (A) of FIG. 3) is held, this image is aligned with the to-be-inspected image 133 shown in (A) of FIG. 3 (or corresponding section image in the to-be-inspected image), a luminance difference is obtained between overlapped pixels to create a difference image 160 ((B) of FIG. 3) and, by using this difference image 160, a defect area is extracted by the same threshold processing as that of the first method.

After the extraction of the defect areas, the defect areas are classified by the classifying unit 108. Steps of a classification procedure will be described below.

Step 1) A feature value of each extracted defect area is calculated. In the semiconductor wafer, because of an effect of a substrate pattern, a dicing line or the like, the same defect may be divided to be extracted during area extraction. Thus, area connection is carried out through a morphology process (Reference: Morphology by Hidefumi Obata, Corona Inc.) or the like when necessary, and then a feature value is calculated.

FIG. 4 shows an example of area connection processing which uses the morphology process (closing process). A continuous resolution failure 170 and unevenness 171 shown in (A) of FIG. 4 become connected defect areas 170-1, 171-1 shown in (B) of FIG. 4 by the area connection process. As feature values, there are those concerning a size, a shape, a position, luminance, a texture of a single area, and an arrangement structure of a plurality of areas, or the like. A feature value in macroinspection is disclosed in Jpn. Pat. Appln. Publication No. 2003-168114 of the inventors. The above area extraction methods and the feature value calculation method can be changed according to classification targets, and contents of the present invention are not limited.

Step 2) A predetermined classification rule is applied to the calculated feature value to determine a category of each area. An example using an IF-THEN rule of a fuzzy theory as a classification rule will be described. In this case, a relation between the feature value and a defect type is represented by IF-THEN forms as follows based on human knowledge or the like, and preset:

(1) IF (area=large AND exposure section dependence=small) THEN (there is a possibility of unevenness)

The exposure section dependence is a feature value indicating a relation with an exposure section position during stepper exposure in wafer manufacturing.

(2) IF (exposure section dependence=large) THEN (a possibility of resolution failure is high)

(3) IF (area=all AND directionality=large) THEN (a possibility of flaw is high)

(4) IF (directionality=large) THEN (there is a possibility of flaw) (5) . . . .

A relation between labels of LARGE and SMALL for a level of each feature value used for the rule and an actual value is set by a membership function shown in FIG. 5, and inference is carried out based on the relation to determine a defect type of each area. An abscissa of the membership function of FIG. 5 indicates an area, and an ordinate indicates goodness of fit. The goodness of fit is a value indicating how much a predetermined feature value matches a target level.

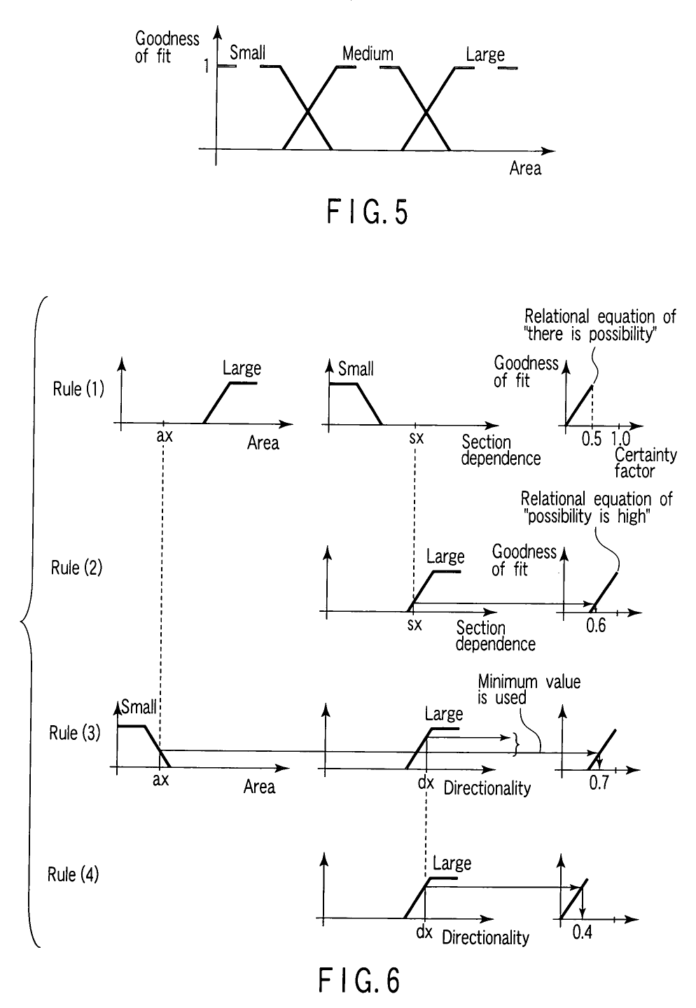

FIG. 6 is an explanatory diagram of a principle of defect type determination based on the classification rule using the membership function. Determination of a defect type of an area X (area=ax, exposure section dependence=sx, directionality=dx) made by using the above four classification rules (1) to (4) will be considered. The rule (1) is a rule indicating a feature value of unevenness, and goodness of fit of the area ax of the area X is 0 with respect to the membership function of area=large. In other words, it is indicated that the area ax is not large. Thus, as the area X does not match the condition of the IF clause, a possibility that the area X is unneveness is eliminated.

Certainty factors are defined as values indicating reliability of such a determination result by numerical values of 0 to 1, and a relational equation is set between goodness of fit and a certainty factor with respect to the IF clause in accordance with contents of the THEN clause.

For example, if the THEN clause is “there is a possibility”, a linear form in which certainty factors are 0 to 0.5 is set. If the THEN clause is “a possibility is high”, a linear form in which certainty factors are 0.5 to 1.0 is set.

As a result, for the area A, a certainty factor of a resolution failure is 0.6 by the rule (2), and a certainty factor of a flaw is 0.7 by the rules (3), (4). Use of a minimum value of goodness of fit of each feature value as goodness of fit of the entire IF clause, and use of certainty factors of the overlapped rules for each defect type are only examples, and other methods may be employed.

At the end, the area X is determined to be a flaw (certainty factor: 0.7). A method may be employed which executes calculation again to realize a total of certainty factors of all the defect types=1, and set unevenness=0/(0+0.6+0.7)=0, a resolution failure=0.6/(0+0.6+0.7)=0.46, and a flaw=0/(0+0.6+0.7)=0.54 as last certainty factors.

As a method other than the method using the inference of the step 2, a step 2′ of a classification method using teacher data will be described.

Step 2′) For the calculated feature value, a defect type of each area is determined based on a relation with teacher data in a feature value space. The teacher data contains a set of pieces of information of a feature value and a correct defect type, and it is prepared beforehand.

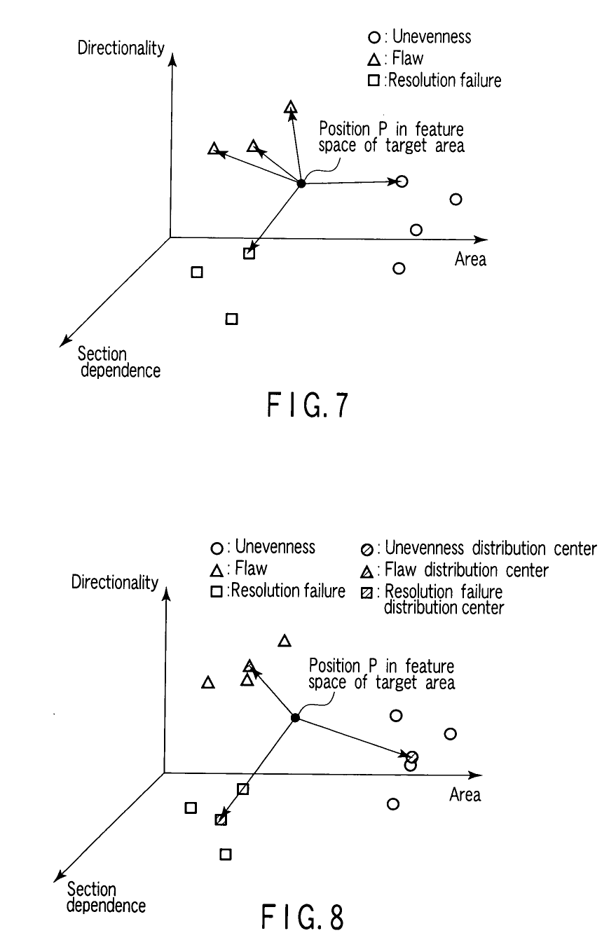

FIG. 7 is an explanatory diagram of a principle of defect determination by a k neighborhood method which is one of the classification methods using the teacher data. ◯, Δ, and □ of FIG. 7 respectively indicate positions of unevenness, a flaw, and a resolution failure in the feature value space of the teacher data. P indicates a position of a classification target area in the feature value space.

The k neighborhood method is a method which sets a defect type largest in number in k (5 in the example [preset]) closest to the target area P as a defect type of the target area. In the example, 3 flaws >2 resolution failures >1 unevenness is set, and target area=flaw is determined because the number of flaws is largest. In the case of this method, distance calculation is necessary between two points (xi: teacher data, xj: classification target) in the feature space (N-dimensional). The following distance calculation methods are available.
<Weighted Euclidean Distance>

$$dij = {\{ {\sum }_{ℓ = 1}^{N} {{w}^{ℓ} ( {x}_{i}^{ℓ} - {x}_{j}^{ℓ} )}^{2} \}}^{1 / 2} \qquad ( 1 )$$

wherein x^{l}i is a value of a feature value l (1≦l≦N), and w^{l} is a weighting factor (preset) for a feature value l.
<Mahalanobis Distance>

$$dij = {\{ {\sum }_{ℓ = 1}^{N} {\sum }_{m = 1}^{N} ( {x}_{i}^{ℓ} - {x}_{j}^{ℓ} ) {v}_{ℓ m} ( {x}_{i}^{m} - {x}_{j}^{m} ) \}}^{1 / 2} \qquad ( 2 )$$

wherein vₗₘ is a (l, m) element of an inverse matrix V⁻¹ of a variance-covariance matrix V of the teacher data of the same defect type. This distance is a distance in a space in which an effect of variance of a distribution of each defect type distribution of the teacher data is normalized.
<Mahalanobis Generalized Distance>

$$dij = {\{ {\sum }_{ℓ = 1}^{N} {\sum }_{m = 1}^{N} ( {x}_{i}^{ℓ} - {x}_{j}^{ℓ} ) {v}_{ℓ m} ( {x}_{i}^{m} - {x}_{j}^{m} ) \}}^{1 / 2} \qquad ( 3 )$$

wherein vₗₘ is a (l, m) element of an inverse matrix V⁻¹ of a variance-covariance matrix V of all the teacher data. This distance is a distance in which an effect of variance of a distribution of all the teacher data is normalized.
<Weighted Urban Area Distance>

$$dij = {\sum }_{ℓ = 1}^{N} {w}^{ℓ} \vert {x}_{i}^{ℓ} - {x}_{j}^{ℓ} \vert \qquad ( 4 )$$

wherein w^{l} is a weighting factor (preset) with respect to a feature value l.

As a method other than the k neighborhood method, as shown in FIG. 8, there is a method which performs classification based on a distance from a representative point (e.g., center) of a teacher data distribution for each defect type. In this case, a value μ^{l} of a feature value l (1≦l≦N) of the representative point is calculated by the following equation, and the above distance calculation is executed to classify defects into a defect type of a shortest distance.

$${μ}^{ℓ} = \frac{1}{n} {\sum }_{i = 1}^{n} {x}_{i}^{ℓ} \qquad ( 5 )$$

wherein n is number of teacher data aggregated into a representative point [same defect type]

For both of the k neighborhood method and the representative point distance comparison method, a calculation load is enlarged as the number of feature values (number of dimensions) is increased. Accordingly, the teacher data may be subjected to main-component analysis to decide a feature value calculation method necessary for classification, and feature value reduction processing may be executed based on this to calculate a distance.

After the classification of defect areas, a representative defect type (=category) of an image is decided by the representative category deciding unit 109. To decide the representative defect type, data of the classification result of the defect areas in the image is first obtained.

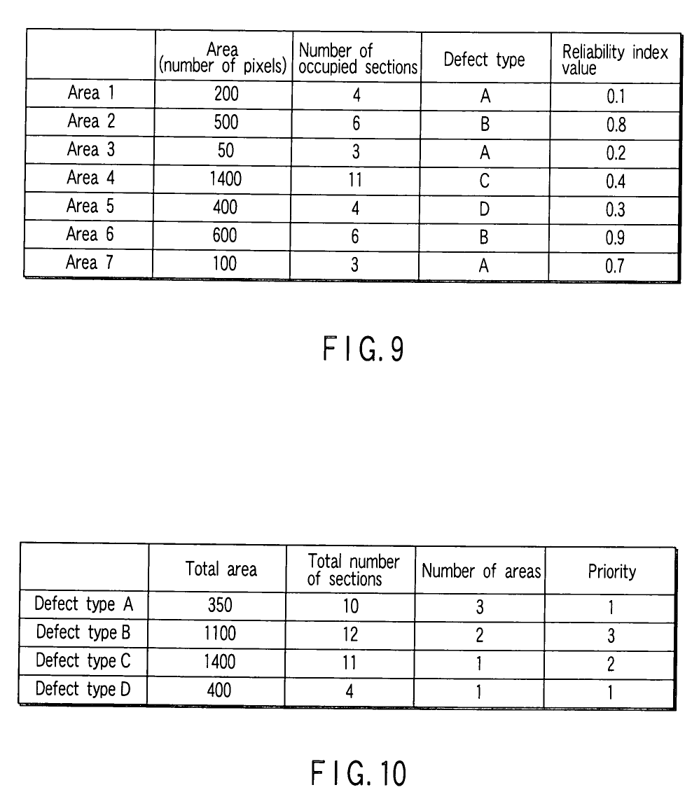

FIG. 9 is a table showing each-area classification result data. In the table, the number of occupied sections is the number of sections of overlapped defect areas when the inside of the image is divided into sections of optional sizes. An advantage of using the number of occupied sections will be described below.

A reliability index value is a value of a certainty factor of determination when classification is carried out by inference of the step 2 of the classifying unit 108. When the k neighborhood method of the step 2′ is used, among k neighbors, an average distance of (plural) teacher data of the same defect type as that of the target areas is set. When the distance comparison with the representative point of the defect type distribution is used, a distance is set from a representative point of a shortest distance (needless to say, representative point of the same defect type distribution as the determined defect type of the target areas). When the certainty factor is used, reliability of a result is higher as the certainty factor is larger. When a distance in the feature value space is used, reliability is higher as the distance is smaller.

Further, classification result data is obtained for each defect type in the image based on the result. FIG. 10 is a table showing this classification result data. In the table, priority indicates a priority level of a defect type when seen from a user of the classification device, and it is preset. Normally, priority is higher for a defect type of a higher criticality (in FIG. 10, priority is higher as a numerical value is larger).

A method for obtaining a representative defect type based on the classification result data will be described. First, as a basic operation, the following are prepared:

“Area number determination”: defect type having a largest number of areas in the image is set as a representative. Ex. defect type A “Total area determination”: defect type having a largest total area in the image is set as a representative. Ex. Defect type C “Total section number determination”: defect type having a largest number of occupied sections in the image is set as a representative. Ex. Defect type B “Priority determination”: defect type having highest priority in the image is set as a representative. Ex. Defect type B

These determinations are ordered by using the input unit 111. For example, when order of “priority determination”→“total section number determination”→“total area determination”→“area number determination” is set, a representative defect type is first decided by the “priority determination” based on a result in the image. The process is finished when the representative is decided. When comparison elements (priorities) are equal, next determinations are executed in order to make decisions. Set contents are given names to be stored, and can be used selectively by the input unit 111 thereafter.

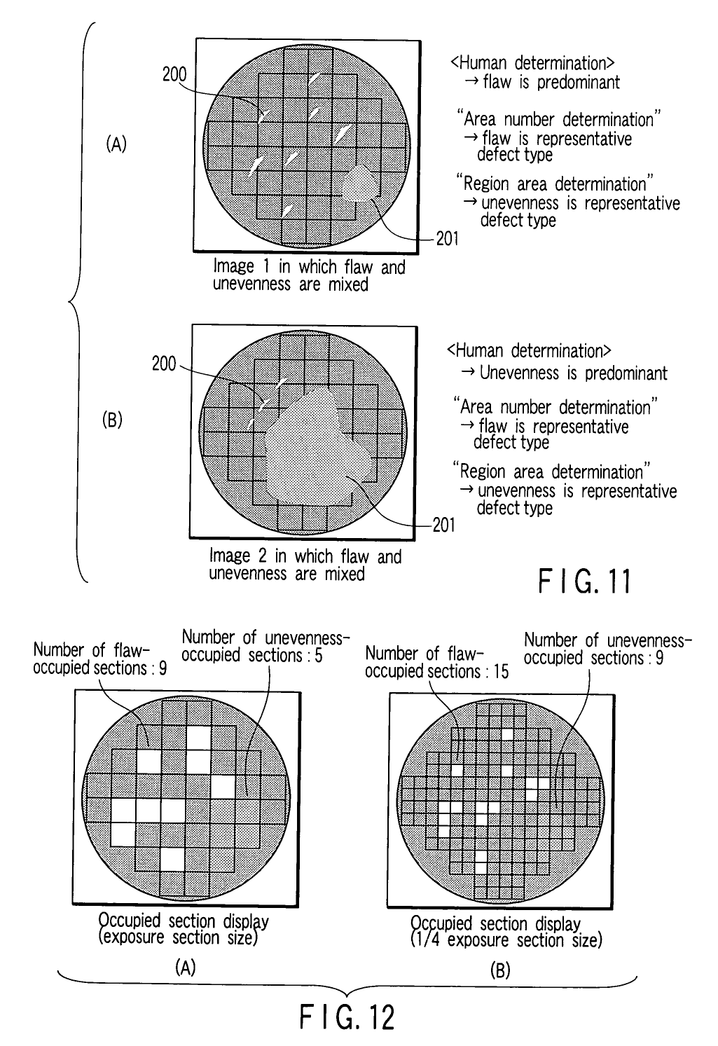

The advantage of using the number of occupied sections will be described below. For example, an image in which many flaws 200 are dispersed and unevenness 201 is partially present as shown in (A) of FIG. 11 will be considered. In this case, a human regards the flaw 200 as a representative defect type in the image. In “area number determination”, as the flaw 200 is determined to be a representative defect type, a correct determination result is obtained. On the other hand, when an image similar to that shown in (B) of FIG. 11 is processed, while the human can determine the unevenness 201 to be a representative defect type, a representative defect type is determined to be a flaw 200 even if the unevenness 201 occupies a major part of the image in “area number determination”.

When “region area determination” is used, the unevenness 201 can be determined to be a representative defect type for the image of (B) of FIG. 11. However, the unevenness 201 is also determined to be a representative defect type for the image of (A) of FIG. 11, and a result is different from human determination.

Accordingly, the number of occupied sections is used when a difference in size between such defect types must be absorbed. FIG. 12 shows a situation of occupied sections of the flaw 200 and the unevenness 201 of (A) of FIG. 11. A section size is an exposure section size of a semiconductor wafer in (A) of FIG. 12, and a section size is a ¼ exposure section size in (B) of FIG. 12. These can be optionally preset. By executing such comparison based on the number of occupied sections, the flaw is determined to be a representative defect type for the image of (A) of FIG. 12, and the unevenness is determined to be a representative defect type for the image of (B) of FIG. 12. Thus, more natural representative defect types can be decided.

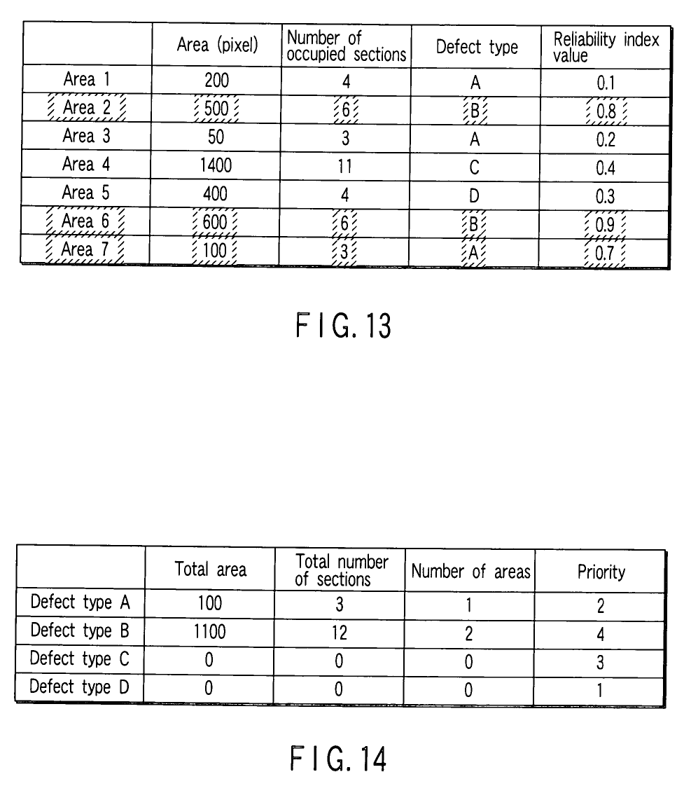

A method for considering a reliability index value will be described below. When determination is focused on an area of high reliability of a classification result, determination is more accurate. Accordingly, an area of high reliability is selected based on a distribution of reliability indexes for the areas in the image to make each of the above determinations. FIG. 13 shows selection of areas of high reliability results indicated by oblique lines in the table of the each-area classification result of FIG. 9. FIG. 14 is a table showing each-defect type classification result data based on the areas selected in FIG. 13.

The following method is available to select an area of high reliability. First, a threshold value Th to bisect a reliability index value is considered. A group L of index values less than Th and a separation index E (obtained by the following equation (6)) of a group U of index values equal to and higher than Th are sequentially set while the threshold value Th is varied between lower and upper limit values. Then, the reliability index value is bisected by Th in which a value of the obtained separation index E is largest to select an area of high reliability.

$$E = \frac{{m}_{U} - {m}_{L}}{{σ}_{U} + {σ}_{L}} \qquad ( 6 )$$

wherein mₓ: average value of group X, σₓ: standard deviation of group X.

In the above consideration of the reliability index value, the setting is carried out by using the input unit 111.

After the representative defect type has been decided, information of the representative defect type (=category) is displayed by the display unit 110.

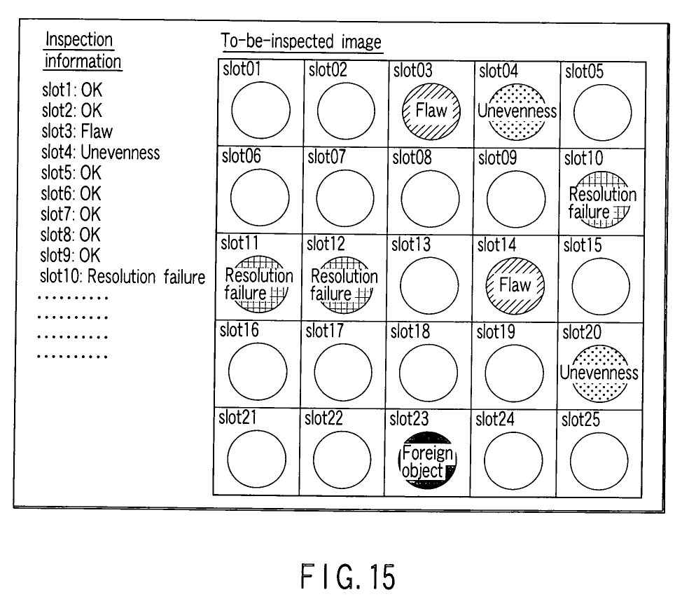

FIG. 15 shows an example of a display screen of the representative defect type. In an inspection information display section 300 of FIG. 15, pieces of information (flaw, unevenness, resolution failure, and the like) of the representative defect type for each of the slots 01 to 25 are displayed. To facilitate checking of correspondence between the classification result and the to-be-inspected image, a reduced to-be-inspected image of each slot is displayed in the to-be-inspected image display section 301.

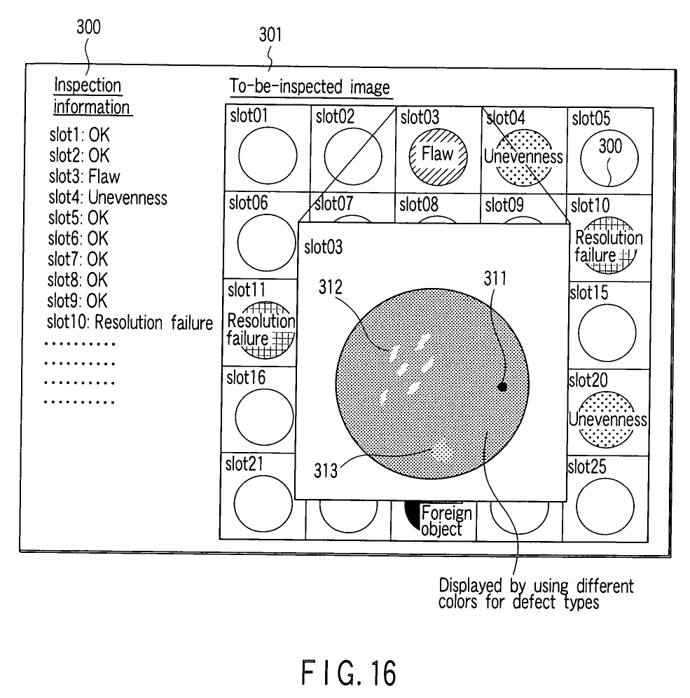

By using the input unit 111 to designate a target whose contents are to be checked more in detail in the display unit 110, defect type information of each area in the designated target is displayed. FIG. 16 shows an example of designating the slot 03 in the display screen of FIG. 15 and displaying a detailed classification result of the slot 03. In this case, when extracted areas of a foreign object 311, a flaw 312, and unevenness 313 or visible outlines of the extracted areas are displayed by using different colors for defect types, a classification result can be quickly checked.

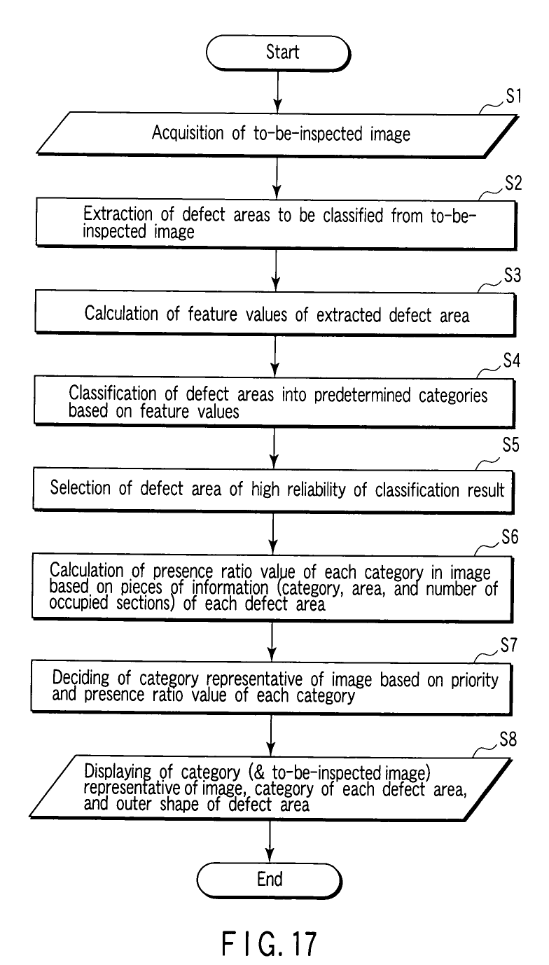

FIG. 17 is a flowchart showing a processing flow of the embodiment. First, a test object is imaged by the CCD camera to obtain a to-be-inspected image (step S1). Defect areas to be classified are extracted from the to-be-inspected image (step S2). Then, feature values of the extracted defect areas are extracted (step S3), and the defect areas are classified into predetermined categories based on the extracted feature values (step S4). An area of high reliability of a classification result is selected (step S5). A presence ratio value of each category in the image is calculated based on pieces of information (category, area, and number of occupied sections) of each area (step S6). A category representative of the image is decided based on priority of each category and a presence ratio value of each category (step S7). Then, the category representative of the image, the to-be-inspected image, the category of each area, and an outer shape of a defect area are displayed (step S8).

According to the present invention, the important category alone in the image can be preferentially checked, the tendency of many test objects can be quickly checked, and the individual classification results in the image can be checked in detail when necessary.

What is claimed is:

1. A classification device comprising:
area extracting unit for extracting a plurality of areas from an image;
classifying unit for classifying the extracted areas into predetermined categories; and
representative category deciding unit for deciding a representative category of the entire image based on a classification result of the areas of the image.

2. The classification device according to claim 1, wherein the representative category is decided by using at least one of a value of a presence ratio of each area in the image, a value indicating reliability of a classification result of each area, and priority of each category.

3. The classification device according to claim 2, wherein the value indicating the presence ratio of the area is represented by at least one of the number of areas for each category in the image, a total area of each category, and the number of occupied sections for each category when the inside of the image is divided into sections by optional sizes.

4. The classification device according to claim 2, wherein the value indicating the reliability is calculated based on a distance of a feature value space used for classification.

5. The classification device according to claim 1, wherein the plurality of classification target areas are defect areas when a surface of a test object is imaged.

6. The classification device according to claim 5, wherein the priority is set in accordance with criticalities of the defect areas.

7. The classification device according to claim 1, wherein the test object is a semiconductor wafer or a flat panel display substrate.

8. The classification device according to claim 7, wherein the image is an interference image or a diffraction image.

9. The classification device according to claim 1, further comprising display unit for switching the detected category of each area with the representative category of the entire image to display the category.

10. The classification device according to claim 9, wherein an image of a processing target is displayed together when the category is displayed by the display unit.

11. The classification device according to claim 10, wherein the image of the processing target is displayed by using different colors for the extracted areas or visible outlines of the extracted areas for each category.

12. A classification method comprising:
a step of extracting a plurality of areas from an image;
a step of classifying the extracted areas into predetermined categories; and
a step of deciding a representative category of the entire image based on a classification result of the areas in the image.
